(19) United States
(12) Patent Application Publication
(10) Pub. No.: US 2026/0220480 A1
(43) Pub. Date: Jul. 30, 2026

(54) FEDERATED/TRANSFER LEARNING FOR O-RAN LLMS

(71) Applicant: Dell Products L.P., Round Rock, TX (US)

(72) Inventors: Gwenael Poitau, Montreal (CA); Ibrahim Abu Alhaol, Nepean (CA); Javad Mirzaei, Toronto (CA); Rohit Arora, San Jose, CA (US); Said Tabet, Austin, TX (US)

(21) Appl. No.: 19/039,407

(22) Filed: Jan. 28, 2025

(51) Int. Cl. G06N 3/096; G06N 3/042; G06N 3/0455

(52) U.S. Cl. CPC G06N 3/096; G06N 3/042; G06N 3/0455

(57) ABSTRACT

One example method is a method for improving O-RAN (open radio access network) LLM (large language model) performance. The example method includes monitoring performance of a task in an O-RAN by an LLM running at an agent deployed in the O-RAN, receiving information from the agent concerning performance of the task, based on the information, generating an update to the LLM, and transmitting the update to the agent, and the update is usable by the agent to update the LLM and/or the associated KG.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Embodiments disclosed herein generally relate to monitoring of wireless networks. More particularly, at least some embodiments relate to systems, hardware, software, computer-readable media, and methods, for federated/transfer learning for O-RAN (open radio access network) LLMs (large language models).

### BACKGROUND

Next generation wireless networks will require customized and real real-time monitoring of detailed complex configurations. Thus, AI/ML (artificial intelligence / machine learning) agents, or optimization modules, may be deployed and co-exist in such a complex network. These agents need to be trained and orchestrated, such as with respect to subscription, training, re re-training, and inferencing, and autonomous enough to manage potential conflicts, which may be explicit or implicit, on their own. One of the most challenging issues is obtaining the granular network data needed to inform timely and accurate decision making.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses a graph indicating the development of LLMs (large language models) and their components in recent years.

FIG. 2 discloses aspects of an AFM (agentic foundation model) reference architecture.

FIG. 3 discloses an example schema, comprising a method and architecture, for federated/transfer learning for O-RAN LLMs, according to one embodiment.

FIG. 4 discloses aspects of one or more methods, according to some example embodiments.

FIG. 5 discloses an example computing entity configured and operable to perform any of the disclosed methods, processes, and operations.

### DETAILED DESCRIPTION OF SOME EXAMPLE EMBODIMENTS

Embodiments disclosed herein generally relate to monitoring of wireless networks. More particularly, at least some embodiments relate to systems, hardware, software, computer-readable media, and methods, for federated/transfer learning for O-RAN (open radio access network) LLMs (large language models).

One or more example embodiments comprise a schema, which may include methods and/or architectures, that implement federated learning and/or transfer learning in the context of an O-RAN. An example method according to one embodiment may be cooperatively implemented by a decision engine and associated global LLM, and a group of AI/ML agents, which may also be referred to herein simply as ‘agents,’ or an ‘agent,’ deployed in a communication network. Each of the AI/ML agents may comprise, or otherwise be associated with, a respective set of one or more LLMs, and a respective set of one or more KBs (knowledge bases) accessible by the LLMs. In an embodiment, an LLM may comprise a GenAI module. Thus, for example, a decision engine may, in cooperation with a global LLM, orchestrate a federated/transfer learning process that involves the AI/ML agents, each of which may operate autonomously, at least with respect to the other AI/ML agents, and each of which is able to communicate with the decision engine. The AI/ML agents may comprise all the AI/ML agents in a network, or may comprise only a designated subset of the AI/ML agents in a network. In an embodiment, each AI/ML agent may be associated with a respective portion and/or aspect of the communication network.

A method according to one example embodiment may be implemented in whole or in part by a decision engine and a group of AI/ML agents, and may comprise operations including: receiving information concerning performance of each of the AI/ML agents; evaluating, using the information, policy-related parameters and knowledge reuse by the AI/ML agents; based on the evaluating, updating a global LLM and global KG based on the information; and, communicating, to one or more of the AI/ML agents, any one or more of a policy update, a KB change, and an LLM update.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that respective LLM instances may be used to enhance a federated/transfer learning process among a group of agents. An embodiment may implement real-time monitoring of agent performance. An embodiment may implement real-time orchestration of a federated/transfer learning process. An embodiment may provided dedicated LLM instances to agents for use by the agents as decision support modules. An embodiment may implement continuous evaluation of one or more of, control policies and their execution by the agents, policy model updates and policy model performance, and knowledge reuse among the agents. Various other advantages of one or more example embodiments will be apparent from this disclosure.

### A. Example context for one or more embodiments

One or more embodiments may apply GenAI (generative artificial intelligence) in the context of communication network environments, such as an O-RAN for example. In this regard, AI/ML (artificial intelligence / machine learning) for communication applications and environments, such as O-RANs for example, faces various challenges, particularly in large scale deployments. Such challenges include generalization limitations, such as for new network topologies and conditions, and obtaining proper coordination of multi-vendor multi-agent solutions.

However, it may be expected that recent progress on GenAI, and LLMs in particular, will open a new era in wireless network optimization by providing unprecedented orchestration and generalization capabilities. In the longer term, GenAI may also help to shape new 6G, and subsequent, paradigms such as semantic communications.

Moreover, the approach to telecom standardization may change, possibly significantly. For example, instead of specifying granular elements of network protocols, new telecom standardization approaches may move instead towards only defining high level concepts, such as slicing for example, and leaving the lower-level granular implementation to GenAI platforms.

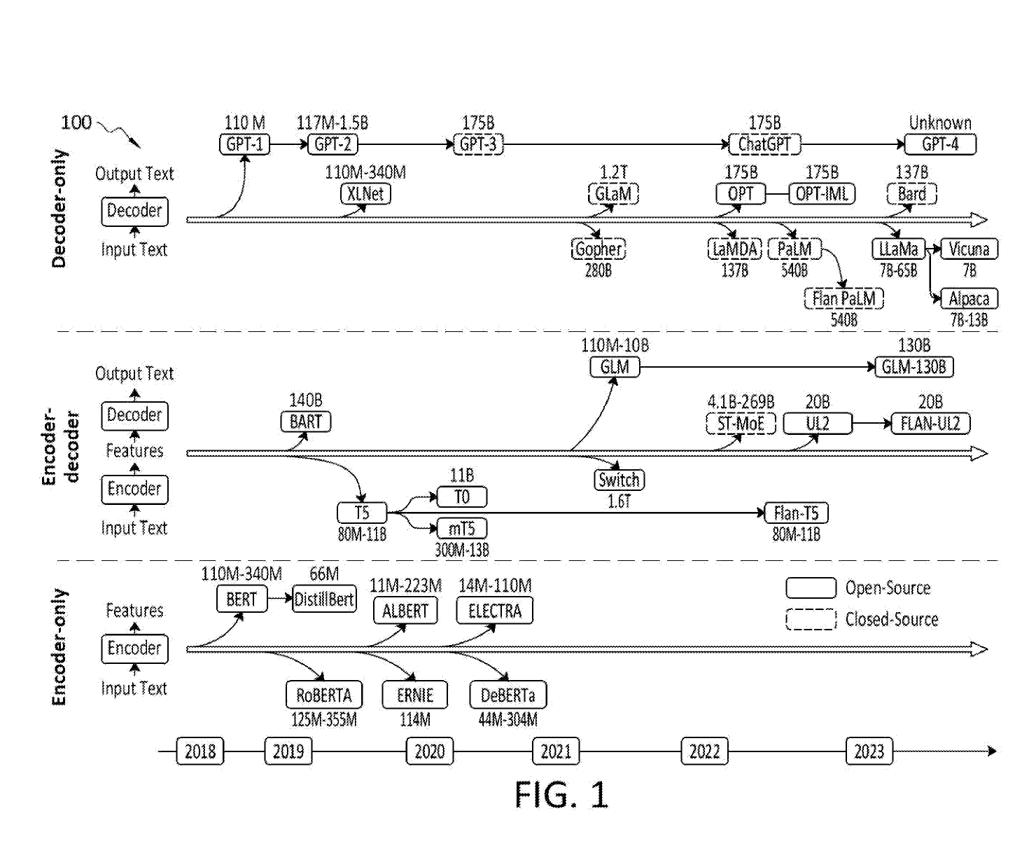

As shown in the example graph 100 disclosed in FIG. 1, the size and architecture of LLMs has progressed significantly between 2018 and 2023. This is particularly true in the areas of encoder-decoder developments, and decoder-only developments. For example, GPT-1 was a key technology in 2018, but has been overtaken by GPT-4 as of2023. By way of contrast, the pace of development of encoder-only platforms has been somewhat slower than that of the decoder-only platforms, and slower than that of the encoder-decoder platforms.

### B. Introduction – Telco Agentic Foundation Model (AFM)

One or more embodiments may employ an AFM in the context of O-RAN operations. As used herein, a Telco Agentic Foundation Model (AFM) may comprise a GenAI module fine-tuned on telecom data which may includes multiple functions to support its decision decision-making ability including, but not limited to, specialized AI/ML agents, knowledge base, and digital twins. One or more embodiments may employ such a GenAI module for functions including, but not limited to, prompt generation, and network configuration definition and refinement.

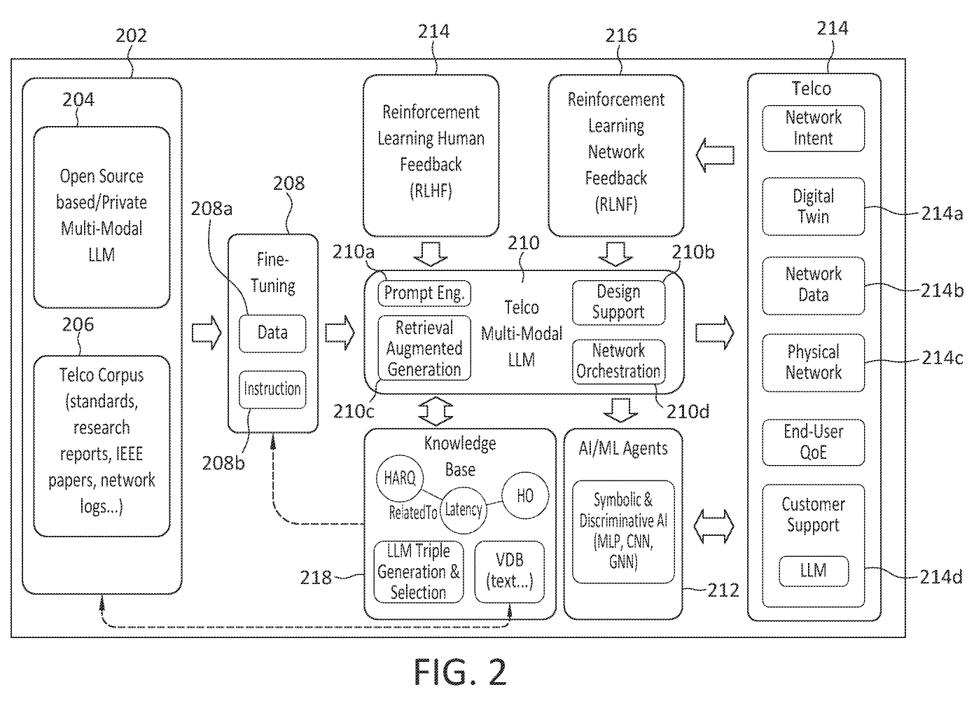

With reference now to FIG. 2, an example AFM reference architecture 200, in which one or more example embodiments may be implemented, is disclosed. This example AFM reference architecture 200 describes various processes and interactions between various components and agents leveraging different knowledge bases, and implementing multiple different LLM instances tuned to achieve specific objectives. Such objectives may include, for example, network operations, network DT (digital twin) and data management, GNN (Graph Neural Network) for network optimization, customer support, and performance evaluation and training.

In more detail, the example architecture 200 may comprise various inputs 202 such as a base-level LLM 204 which may take the form of an open source based/private multi-modal LLM, and various information 206 such as a telco corpus for example. The inputs 202 may be provided to a fine-tuning module 208 that may tune the base-level LLM 204 to create a more specific LLM implementation, such as a telco, or O-RAN, multi-modal LLM 210. In addition to the inputs 202, the fine-tuning module 208 may also comprise a dataset 208a, and various instructions 208b, which may both be used in a fine tuning process.

The multi-modal LLM 210 may operate to define, and orchestrate, such as in cooperation with one or more AI/ML agents 212, one or more elements of a network configuration 214, or elements of an O-RAN. To these, and other, ends, the multi-modal LLM 210 may comprise various components, such as prompt engineering 210a, design support 210b, RAG 210c, and a network orchestration module 210d. In connection with its operations, the multi-modal LLM 210 may receive various inputs, such as reinforcement learning human feedback 214, and reinforcement learning network feedback 216, both of which may be used by the multi-modal LLM 210 to define, implement, and refine, the network configuration 214. Further, the reinforcement learning feedback, as well as historical log information concerning usage and configuration of networks, may be used to generate forecasts as to changes to the configuration, and use, of one or more private networks. As well, the multi-modal LLM 210 may draw from, and make deposits to, a knowledge base 218, concerning the operations of the multi-modal LLM 210.

Finally, the network configuration 214 may comprise various elements. Such elements may include, but are not limited to, a digital twin 214a, network data 214b concerning network operations, events, and configurations, a physical communication network 214c, and a customer support module 214d which may comprise, for example, a virtual assistant such as a chatbot that comprises an LLM.

### C. Detailed discussion

### C.1 Introduction

One embodiment may employ various LLM instances, each of which may be dedicated to a respective AI/ML agent, and each of which may be trained, and/or fine-tuned, on one or more pre-selected O-RAN datasets that may or may not be local to the AI/ML agent. Each of the LLM instances may be configured to perform a specific task or group of tasks, which may be specific to the AI/ML agent with which the LLM instance is associated. In an embodiment, an AI/ML agent may be concerned some particular aspect of an O-RAN. For example, an AI/ML agent and its associated LLM instance(s) may be concerned with monitoring and controlling the performance of a particular service/component in an O-RAN, where such services and components include, but are not limited to, data security, network components, telemetry collection, user access, latency control, data transmission, execution of third party applications, conflict mitigation, and any other network components, and services performed in, or in associate with, an O-RAN.

In an embodiment, each AI/ML agent deployed in an O-RAN is associated with a respective set of one or more LLM instances which may each operate to enable dynamic orchestration and implementation of defined objectives on a per-agent basis. An LLM instance may be trained for one or more particular tasks using data local to the associated AI/ML agent and/or, in a federated/transfer learning process, using data received from other AI/ML agents.

An embodiment may comprise a decision engine component that communicates with the AI/ML agents and operates to orchestrate a transfer learning process among the AI/ML agents in a group of AI/ML agents. For example, the decision engine may determine, possibly with the aid of a global-LLM, what information or data is transferred among AI/ML agents, when the information should be transferred, and how much local training may need to be performed at the AI/ML agents after the information transfer is completed. The decision engine may monitor the performance of each agent as the agent carries out, such as by way of its LLM(s), its various tasks.

In an embodiment, each agent may access a respective KB (knowledge base) that includes information and data about the O-RAN. The information and data in a KB may be associated with the task(s) that the corresponding agent is responsible to perform in the O-RAN. A KB may comprise data generated an/or collected by the agent in connection with performance of its tasks. Further, the information and data in a KB may be used to train LLM instances associated with the agent, and that information and data may be transferred to one or more other agents, such as by way of a decision engine. The KB can be presented, but not limited, as knowledge graph with enriched features that represent the local network status and constraints.

In an embodiment, a KB may comprise a KG (knowledge graph), which may or may not be rendered in a visual form, that comprises nodes which each represent a respective entity of an O-RAN, where an entity may comprise hardware and/or software. A KG may also comprise edges connecting the nodes, where each of the edges indicates the nature of a relationship between the nodes connected by that edge.

A KB in the form of a KG may enable accuracy in terms of the structure and relationships of an O-RAN. As well, a KG may comprise contextual network information, such as nodes and edges, that may extend over various portions of an O-RAN, such as regions, and specific locations, for example, and/or portions of an O-RAN that share one or more characteristics other than regional/locational similarity. For example, a KG might comprise nodes corresponding to all servers in an O-RAN, an embodiment of a KG might comprise nodes that are all located within a specified geographical area, and an embodiment of a KG might comprise nodes that all perform the same function or group of functions. Thus, a KG according to an embodiment may be defined and configured in a variety of different ways.

### C.2 Discussion

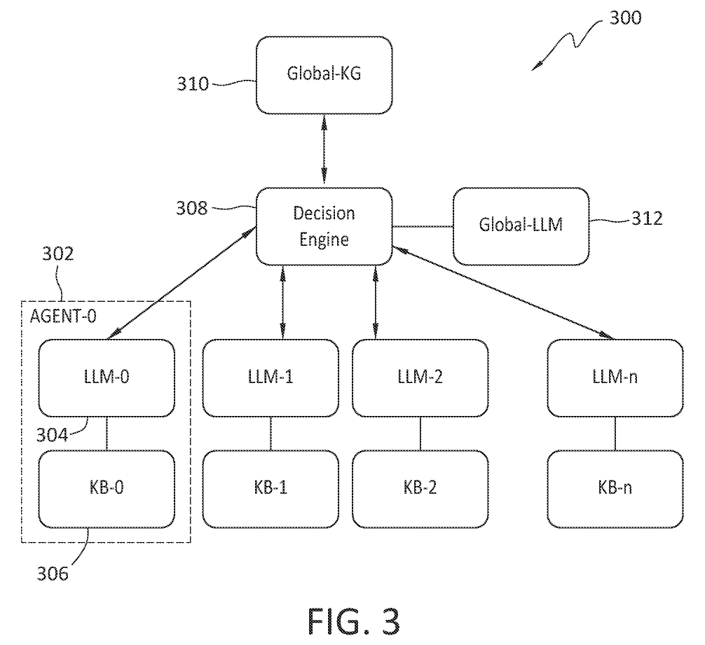

With reference now to FIG. 3, an example schema 300 according to one embodiment is disclosed. The schema 300 may be configured, and used, to implement a federated/transfer learning process in a communications environment, such as an O-RAN for example.

By way of overview, one embodiment may comprise LLM instances dedicated to respective agents and which may be implemented in, and enhance, a federated and transfer learning operational architecture. The schema 300 may provide real -time monitoring of AI/ML agent performance, and orchestration of a federated and transfer learning process. In an embodiment, O-RAN LLM instances are dedicated to AI/ML agents and operate as decision support modules for the agents. In an embodiment, a decision engine may continuously evaluate, and control, policies and their execution by the agents, policy model(s) updates and performance, and knowledge reuse among the agents and LLMs.

As shown in FIG. 3, the schema 300 may comprise an O-RAN that includes various agents 302. It is noted that for clarity purposes, only one agent is specifically referenced in the example of FIG. 3. Each of the agents 302 may comprise, or otherwise be associated with, a respective set of one or more LLMs 304, and with a respective KB 306. The KBs 306 may each comprise a respective KG that captures a network, or a portion of a network, such an O-RAN for example, with which the task(s) of the associated agent 302 is/are concerned. The network information in the KB 306 may be used by the agent 302 to carry out those tasks. Because the information in the KB 306 may be focused and limited, such as in terms of a particular portion, or aspect, of a network, the information in the KB 306 may have a high degree of granularity with respect to the overall network. The granularity of this information may be used to aid decision-making by the LLM 304.

As well, the granularity of the information in the KB 306 may enable a focused approach to LLM 304 updates. In particular, in one embodiment, only the LLM, or LLMs, that need to be updated and retrained will be updated and retrained. LLMs that do not require retraining may remain unmodified. In this way, LLM retraining across the network may be minimized.

Information in the KB 306 may be accessed and used by the LLM 304 to make decisions concerning the implementation of tasks and objectives of the agent 302. In an embodiment, the LLM 304 may be pre-trained, prior to deployment in connection with the agent 302, using a pre-selected O-RAN dataset that includes information and data concerning network configuration and operations that relate to the tasks and objectives of the agent 302.

With continued reference to the example of FIG. 3, an embodiment may comprise a decision engine 308 that communicates with the agents 302. For example, the decision engine 308 may receive information and data collected and/or generated by each of the agents 302 concerning objectives targeted and, tasks performed, by the agents 302. For example, information received by the decision engine 308 from an agent 302 may include, but is not limited to, feedback generated by performance of a task by the agent 302 such as whether or not an objective of an agent was achieved, information concerning a change in the structure or operation of a portion of an O-RAN in which the task is performed by the agent 302, and information indicating the performance of the LLM.

Information received by the decision engine 308 may be used by the decision engine 308 to update a global KG 310 that comprises a representation of the entire O-RAN. In this way, users and administrators may have access to a complete, and up to data, representation of the O-RAN. In an embodiment, the information received by the decision engine 308 may be used by the decision engine 308 to update a global LLM 312. In an embodiment, the global LLM 312 may comprise a model, or models, operable to run any of the tasks that have been assigned to the various agents 302.

Since the global LLM 312 has access to up to date information received by the decision engine 318 from the agents 302, the global LLM 312 may update one or more tasks using that information. The global LLM 312 may also generate task specific updates to one or more of the LLMs 302, and those updates may then be promulgated back to one or more of the agents 302 by the decision engine 308. These model updates may be implemented by the agents 302 in the LLM 304, and the updated LLM 304 trained with information received from one or more other agents 302 by the decision engine 308.

The amount of training needed, and the type and amount of data to be transferred from one agent 302 to another agent 302, may be specified by the decision engine 308. The information transferred to an agent 302 may be used by the agent 302 to update its KB 306.

In an embodiment, the decision engine 308 may monitor, in real-time, the performance of tasks by an agent 302. The decision engine 308 may also monitor an orchestration process in which LLM 304 updates, and data/information, are pushed out to the agents 302 by the decision engine 308. In an embodiment, the decision engine 308 may continuously, and possibly in real time, monitor and evaluate policies implemented, and executed, by the LLM 304 in connection with the performance of tasks assigned to the agent 302. The decision engine 308 may also monitor and evaluate, in real time, model updates, and the implementation of model updates, such as policy updates, in the LLM 304. As a final example, the decision engine 308 may monitor and evaluate, in real time, the use by an agent 302 of information received by the agent 302 from another agent as part of a federated/transfer learning process.

### D. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

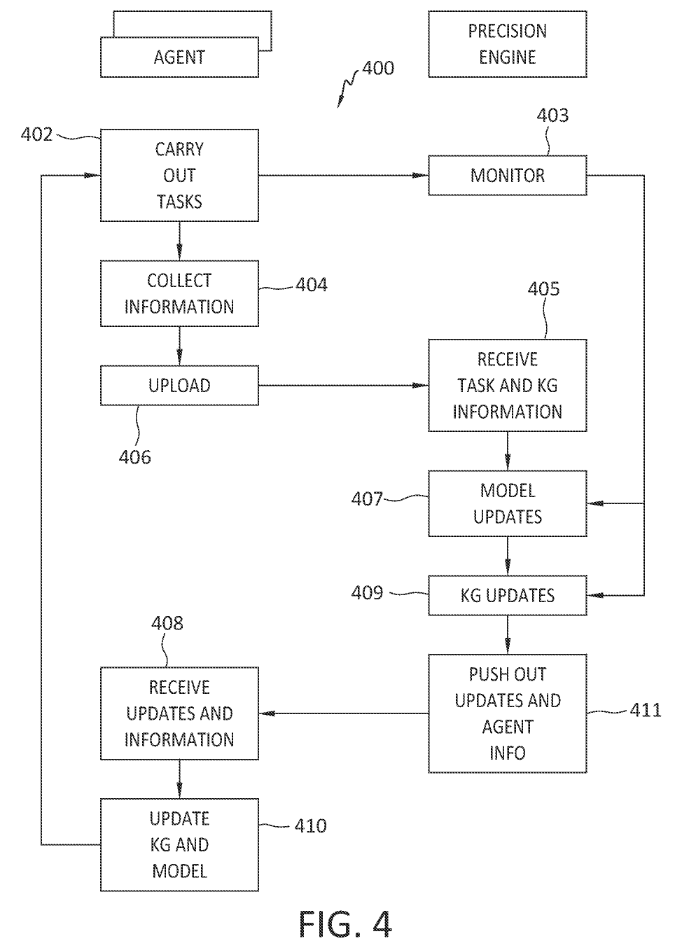

Directing attention now to FIG. 4, a method 400 according to one embodiment is disclosed. In an embodiment, the method 400 may be performed by a decision engine in cooperation with one or more agents deployed in an O-RAN. In the example of FIG. 4, the method 400 may begin with the carrying out 402 of various tasks by an agent, or agents. The performance 402 of the tasks may be monitored 403 by a decision engine. Before, during, and/or after, performance 402 of the tasks, the agent(s) may collect 404 information concerning the performance 402 of those tasks. Such information may include, for example, whether or not the tasks were successfully performed, when the tasks were performed, and where. The information may also include network resource, such as processing, storage, and memory, consumption by the tasks, and the information may include KG information concerning the structure and operation of the O-RAN, or portion thereof, where the tasks were carried out 402. The information collected 404 may be uploaded 406 by the agent(s), synchronously or asynchronously, to the decision engine.

After receipt 405 of the information and the KG information, the decision engine may create, or direct the creation of, updates 407 to the respective LLM(s) and updates 409 to the KG of one or more of the agents. After the LLM updates have been created 407, and the KG updates made 409, the LLM updates and KG updates may be pushed out 411 to one or more of the agents including, but not limited to, the agent from which the task and KG information was received 405.

The agent(s) may then receive 408 LLM updates, KG updates, and other information from one or more other agents. These various updates and information may then be used by the agent(s) to update 410 a respective KG and LLM. The method 400 may then return to 402. Thus, as exemplified in FIG. 4, a method according to one embodiment may be performed recursively to continually monitor, evaluate, and improve, the performance of one or more O-RAN LLMs and associated KBs.

### E. Further Example Embodiments

Following are some further example embodiments. These are presented only by way of example and are not intended to limit the scope of this disclosure or the claims in any way.

Embodiment 1. A method for improving O-RAN (open radio access network) LLM (large language model) performance, comprising: monitoring performance of a task in an O-RAN by an LLM running at an agent deployed in the O-RAN; receiving information from the agent concerning performance of the task; based on the information, generating an update to the LLM; transmitting the update to the agent, and the update is usable by the agent to update the LLM.

Embodiment 2. The method as recited in claim 1, wherein information from one or more other agents is transmitted to the agent along with the update.

Embodiment 3. The method as recited in claim 2, wherein the information from the other agents comprises KG (knowledge graph) information from respective KGs of the other agents.

Embodiment 4. The method as recited in claim 1, wherein the information received from the agent comprises a change to a KG associated with the agent.

Embodiment 5. The method as recited in claim 1, wherein the information received from the agent is used to update one or both of a global KG, and a global LLM.

Embodiment 6. The method as recited in claim 1, wherein the monitoring is performed in real time.

Embodiment 7. The method as recited in claim 1, wherein the update is transmitted to fewer than all agents in the O-RAN.

Embodiment 8. The method as recited in claim 1, wherein the task is specific to the agent.

Embodiment 9. The method as recited in claim 1, wherein instructions are transmitted to the agent indicating how much local training of the LLM at the agent is required after the update is incorporated in the LLM.

Embodiment 10. The method as recited in claim 1, wherein the update is based in part on information received from one or more other agents in the O-RAN.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

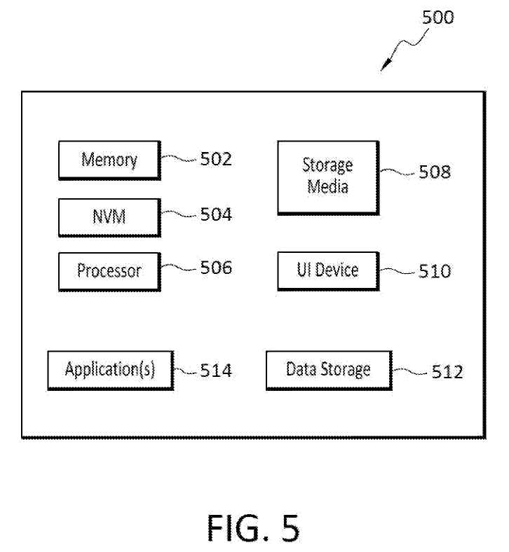

With reference briefly now to FIG. 5, any one or more of the entities disclosed, or implied, by FIGS. 1-4, and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method for improving O-RAN (open radio access network) LLM (large language model) performance, comprising:
monitoring performance of a task in an O-RAN by an LLM running at an agent deployed in the O-RAN;
receiving information from the agent concerning performance of the task;
based on the information, generating an update to the LLM; and
transmitting the update to the agent, and the update is usable by the agent to update the LLM.

2. The method as recited in claim 1, wherein information from one or more other agents is transmitted to the agent along with the update.

3. The method as recited in claim 2, wherein the information from the other agents comprises KG (knowledge graph) information from respective KGs of the other agents.

4. The method as recited in claim 1, wherein the information received from the agent comprises a change to a KG associated with the agent.

5. The method as recited in claim 1, wherein the information received from the agent is used to update one or both of a global KG, and a global LLM.

6. The method as recited in claim 1, wherein the monitoring is performed in real time.

7. The method as recited in claim 1, wherein the update is transmitted to fewer than all agents in the O-RAN.

8. The method as recited in claim 1, wherein the task is specific to the agent.

9. The method as recited in claim 1, wherein instructions are transmitted to the agent indicating how much local training of the LLM at the agent is required after the update is incorporated in the LLM.

10. The method as recited in claim 1, wherein the update is based in part on information received from one or more other agents in the O-RAN.

11. A non-transitory storage medium having stored therein instructions that are executable by one or more hardware processors to perform operations comprising:
monitoring performance of a task in an O-RAN by an LLM running at an agent deployed in the O-RAN;
receiving information from the agent concerning performance of the task;
based on the information, generating an update to the LLM; and
transmitting the update to the agent, and the update is usable by the agent to update the LLM.

12. The non-transitory storage medium as recited in claim 11, wherein information from one or more other agents is transmitted to the agent along with the update.

13. The non-transitory storage medium as recited in claim 12, wherein the information from the other agents comprises KG (knowledge graph) information from respective KGs of the other agents.

14. The non-transitory storage medium as recited in claim 11, wherein the information received from the agent comprises a change to a KG associated with the agent.

15. The non-transitory storage medium as recited in claim 11, wherein the information received from the agent is used to update one or both of a global KG, and a global LLM.

16. The non-transitory storage medium as recited in claim 11, wherein the monitoring is performed in real time.

17. The non-transitory storage medium as recited in claim 11, wherein the update is transmitted to fewer than all agents in the O-RAN.

18. The non-transitory storage medium as recited in claim 11, wherein the task is specific to the agent.

19. The non-transitory storage medium as recited in claim 11, wherein instructions are transmitted to the agent indicating how much local training of the LLM at the agent is required after the update is incorporated in the LLM.

20. The non-transitory storage medium as recited in claim 11, wherein the update is based in part on information received from one or more other agents in the O-RAN.
